(19) United States
(12) Patent Application Publication
(10) Pub. No.: US 2006/0255707 A1
(43) Pub. Date: Nov. 16, 2006

(54) Lamp base having color coding and lamp having a lamp base

(75) Inventors: Peter Helbig, Sontheim/Brenz (DE); Uwe Kantim, Heidenheim (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/430,110

(22) Filed: May 9, 2006

(30) Foreign Application Priority Data
May 10, 2005 (DE) 102005021596.3

(51) Int. Cl. H01J 5/48

(52) U.S. Cl. 313/318.01

(57) ABSTRACT

The invention relates to a lamp base having a color coding, the coding being formed by a plastic part, which is made from a colored plastic material. In addition, the invention relates to a lamp, preferably a vehicle lamp, having such a lamp base.

### I. TECHNICAL FIELD

The invention relates to a lamp base having a color coding and to a lamp having such a lamp base.

### II. BACKGROUND ART

Such a lamp base has been disclosed, for example, in the German design 40403737.2. This design has two different types of H7 lamps, whose metal bases are provided on the underside with a color coding. Said coding is in the form of a colored layer, in the form of a ring segment, on a metal ring of the lamp base.

### III. DISCLOSURE OF THE INVENTION

The object of the invention is to provide a generic lamp base and a lamp having such a base, said lamp base or lamp having improved color coding. In particular, the coding should have increased durability.

This object is achieved according to the invention by a lamp base having a color coding, wherein the coding is formed by a plastic part, which is made from a colored plastic material. Particularly advantageous embodiments of the invention are described in the dependent claims.

In the case of the lamp base according to the invention, the color coding is in the form of a plastic part, which is made from a colored plastic material. As a result, the color coding is more durable than the colored layer disclosed in the prior art. In particular, the coding of the lamp base according to the invention is designed to be scratch-resistant. In addition, there is also no risk of the coding being discolored or of it peeling off during the life of the lamp.

The plastic part forming the color coding is advantageously fixed at a point on the lamp base which is visible from the outside, in a cutout in the lamp base, in order to provide the user of the lamp with information on the lamp type by means of the color of the plastic part and in order to make it possible to fix the plastic part in the lamp base in a reliable manner. The colored plastic material of the plastic part preferably has a different color than the lamp base or than the lamp base part in which the plastic part is fixed, in order to ensure good visibility.

The abovementioned plastic part is preferably in the form of a pin, which is arranged with a snug fit in the cutout in the lamp base. This ensures that the plastic part is fixed in the cutout in a reliable manner. In accordance with the preferred exemplary embodiment of the invention, the cutout is in the form of a drilled hole, in which the pin is arranged with a snug fit. The colored plastic pin can thus be fixed in the drilled hole purely mechanically, with a clamping fit. The pin is preferably arranged in the drilled hole over its entire length, with the result that only one of its ends is visible.

### IV. BRIEF DESCRIPTION OF THE DRAWINGS

The invention will be explained in more detail below with reference to a preferred exemplary embodiment. In the drawing:

FIG. 1 shows a cross section through a part of the lamp base in accordance with the preferred exemplary embodiment of the invention,

FIG. 2 shows a plan view of the underside of the lamp base part depicted in FIG. 1,

FIG. 3 shows a side view of the colored plastic pin, which is fixed in a drilled hole in the lamp base part illustrated in FIGS. 1 and 2, and

FIG. 4 shows a side view of the complete lamp with the lamp base part depicted in FIGS. 1 and 2.

### V. BEST MODE FOR CARRYING OUT THE INVENTION

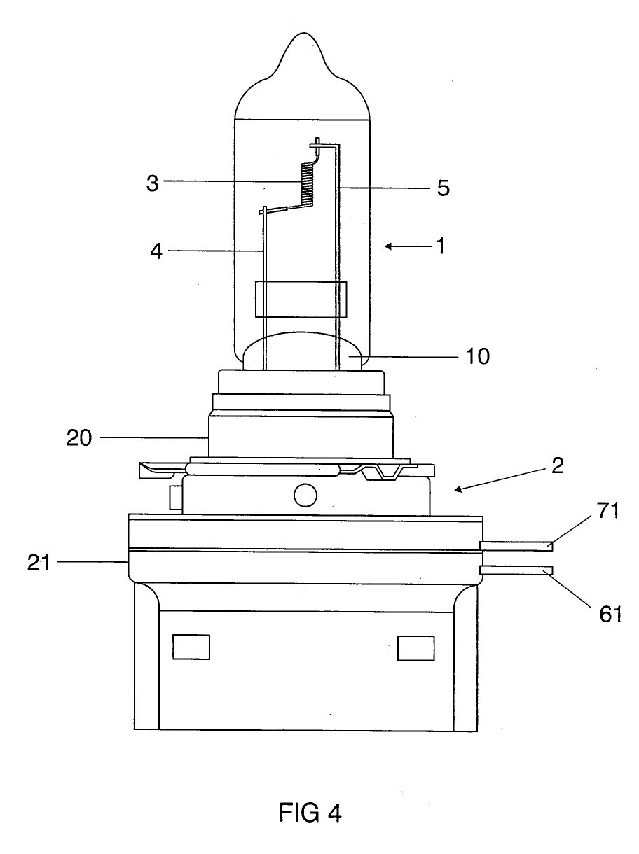

The preferred exemplary embodiment of the lamp according to the invention depicted in FIG. 4 is a halogen incandescent lamp of the H11 lamp type, which can be used in a motor vehicle headlight, for example for the purpose of producing the lower beam, the upper beam or the foglight. This lamp has a vitreous lamp vessel 1 having a sealed end 10, which is anchored in a base 2. Arranged in the interior of the lamp vessel 1 is an axially aligned incandescent filament 3, whose outgoing filament sections are each connected to a power supply wire 4, 5 which is passed out of the sealed end 10. The base 2 is a so-called metal/plastic base. That is to say it has both metallic and plastic base parts. The sealed end 10 of the lamp vessel 1 is anchored in the metallic base part 20. The metallic base part 20 is in turn fixed in the plastic base part 21, which is provided with two electrical connections 61, 71. The electrical connections are each made from a metal sheet and each have a first end 61, 71, which is provided with a contact face and protrudes in the radial direction out of the plastic base part 21, with the result that the contact faces of these ends 61, 71 are arranged at a short distance one above the other or next to one another in different planes perpendicular with respect to the longitudinal axis of the headlamp.

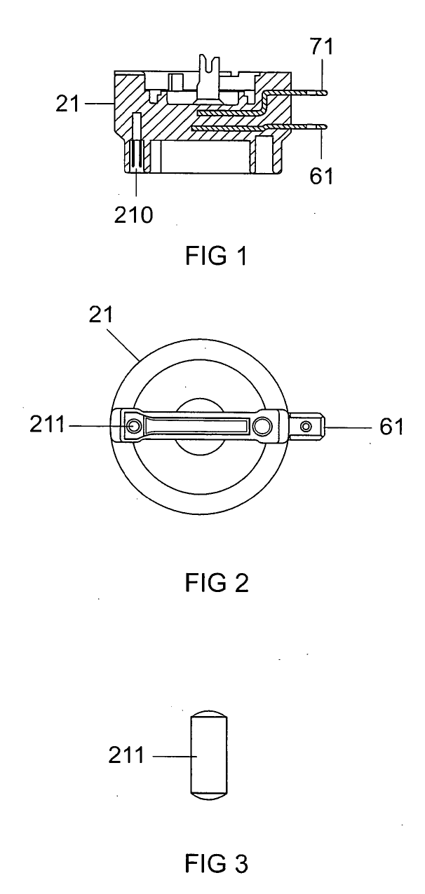

FIG. 1 shows a cross section through the plastic base part 21, which is made from a black plastic, for example from Ryton. The plastic base part 21 is provided with a drilled hole 210 in its underside, i.e. in the side remote from the lamp vessel 1, said drilled hole 210 extending parallel to the longitudinal axis of the lamp. A colored plastic pin 211 (depicted in FIG. 3) is arranged in this drilled hole 210 with a snug fit. The plastic pin 211 is made from, for example, blue or orange-colored polyamide and has a length of 6 millimeters and a thickness of 2.45 millimeters. It is arranged over its entire length in the drilled hole 210, with the result that only the head or the end of the plastic pin 211 is visible from the underside of the lamp base part 21 (FIG. 2). Different versions of the same lamp type are equipped with plastic pins 211 of different colors in order to make it possible to distinguish between them in a simple manner. For example, the user of the lamp can distinguish the standard H11 lamp from its long-life version or from a version having an increased color temperature in a simple manner by means of plastic pins having different colors. This ensures that different versions of the same lamp type cannot be used in the vehicle when a defective lamp is replaced.

The invention is not restricted to the exemplary embodiment which has been explained in more detail above, but can also be used for lamps having a metal base and for lamps for general lighting.

1. A lamp base having a color coding, wherein the coding is formed by a plastic part, which is made from a colored plastic material.

2. The lamp base as claimed in claim 1, wherein the plastic part is fixed at a point which is visible from the outside, in a cutout in the lamp base.

3. The lamp base as claimed in claim 2, wherein the plastic part is in the form of a pin, which is arranged with a snug fit in the cutout.

4. The lamp base as claimed in claim 3, wherein the cutout is in the form of a drilled hole.

5. A lamp having a lamp base as claimed in claim 1.
